(19) United States
(12) Patent Application Publication
(10) Pub. No.: US 2025/0124725 A1
(43) Pub. Date: Apr. 17, 2025

(54) DATA ACQUISITION SYSTEMS FOR COCKPITS

(71) Applicants: David Rankin, Centennial, CO (US); Charles Rankin, Centennial, CO (US); Theodore Rankin, Centennial, CO (US)

(72) Inventors: David Rankin, Centennial, CO (US); Charles Rankin, Centennial, CO (US); Theodore Rankin, Centennial, CO (US)

(21) Appl. No.: 19/002,026

(22) Filed: Dec. 26, 2024

Related U.S. Application Data
(60) Provisional application No. 63/551,791, filed on Feb. 9, 2024.

(51) Int. Cl. G06V 20/59; B64D 45/00; G06V 20/70; H04N 7/18

(52) U.S. Cl. CPC G06V 20/59; B64D 45/00; G06V 20/70; H04N 7/183; G06V 2201/02

(57) ABSTRACT

Data acquisition systems including an image capture device and a data processing system. The image capture device is positioned to capture a cockpit image of a plurality of instruments. The data processing system is in data communication with the image capture device and configured to process the cockpit image to yield cockpit data. The cockpit data includes a current value of the instruments. The data processing system includes a memory unit, computer instructions, and a processor. The processor is in data communication with the memory unit and the image capture device. The processor is configured to execute the computer instructions to yield the cockpit data. The computer instructions instruct the processor to receive the cockpit image, identify instrument images, assign labels to the instrument images, determine current values of instruments based on optical data, and save the current values into data records associated with the instrument labels.

### CROSS REFERENCE TO RELATED APPLICATIONS

This application claims priority to copending U.S. Application, Ser. No. 63/551,791, filed on Feb. 9, 2024, which is hereby incorporated by reference for all purposes.

### BACKGROUND

The present disclosure relates generally to data acquisition systems. In particular, data acquisition systems for cockpits are described.

In avionics, data from instruments and controls throughout a flight is recorded for later reference. The recorded flight data is especially useful in the event of an airplane crash or malfunction. Recorded flight data is also useful for maintenance and training purposes.

The conventional approaches to acquiring and recording flight data are not ideal. Conventionally, analog/digital converter boxes are wired to instruments and controls behind instrument panels to acquire flight data. Further, analog/digital converter boxes must be wired to flight data recorders to transfer the acquired flight data to the flight data recorder.

Installing and wiring analog/digital converter boxes behind an instrument panel is costly, time consuming, and requires skilled technicians. Conventional analog/digital converter box based approaches are tedious and inefficient because each individual instrument and control must be individually wired to an analog/digital converter box to acquire data from them.

It would be desirable to acquire flight data from instruments and controls in a cockpit without needing to install wiring and analog/digital behind an instrument panel. It would be further desirable to have a system effective to acquire flight data from a plurality of instruments and controls without needing to individually wire each control and gauge to an analog/digital converter box.

Thus, there exists a need for data acquisition systems that improve upon and advance the design of conventional systems for acquiring flight data and transferring it to a flight data recorder. Examples of new and useful data acquisition systems relevant to the needs existing in the field are discussed below.

### SUMMARY

The present disclosure is directed to data acquisition systems including an image capture device and a data processing system. The image capture device is positioned to capture a cockpit image of a plurality of instruments mounted in a cockpit. The data processing system is in data communication with the image capture device and configured to process the cockpit image to yield cockpit data. The cockpit data includes a current value of one or more of the plurality of instruments captured in the cockpit image.

The data processing system includes a memory unit, computer instructions stored in the memory unit, and a processor. The processor is in data communication with the memory unit and the image capture device. The processor is configured to execute the computer instructions to yield the cockpit data.

The computer instructions instruct the processor to receive the cockpit image, identify instrument images, assign labels to the instrument images, determine a current value of a selected instrument based on optical data, and save the current value into a data record associated with a selected instrument label.

### BRIEF DESCRIPTION OF THE DRAWINGS

FIG. 1 is a perspective view of a first example of a data acquisition system in an airplane cockpit optically acquiring cockpit data.

FIG. 2 is a cockpit image of the airplane cockpit captured for optical processing by the data acquisition system shown in FIG. 1.

FIG. 3 is the cockpit image shown in FIG. 2 with a user interface overlay added by the data acquisition system shown in FIG. 1, the user interface overlay includes boxes around individual instruments and controls in the cockpit.

FIG. 4 is an instrument image of a selected instrument from the cockpit image shown in FIG. 3 and a view of the selected instrument image with labels schematically depicting optically identified instrument values.

FIG. 5 is a flow diagram of computer instructions executed by a processor of the data acquisition system shown in FIG. 1.

FIG. 6 is a flow diagram of computer instructions for determining a current value of an instrument with the data acquisition system shown in FIG. 1.

FIG. 7 is a flow diagram of computer instructions for determining a current setting of a control with the data acquisition system shown in FIG. 1.

### DETAILED DESCRIPTION

The disclosed data acquisition systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various data acquisition systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

### Contextual Details

Ancillary features relevant to the data acquisition systems described herein will first be described to provide context and to aid discussing the data acquisition systems.

### Cockpit

The data acquisition systems described in this document are often used in aircraft cockpits, such as airplane and helicopter cockpits, but may be used in any application that includes controls, gauges, instruments, or control screens. For example, the data acquisition systems may be used with land vehicles, such as passenger vehicles, trains, tractors, forklifts, and other vehicles or equipment. In some applications, the data acquisition systems are used in control centers of production facilities where operators monitor temperature, pressure, volume, and various control settings of production equipment.

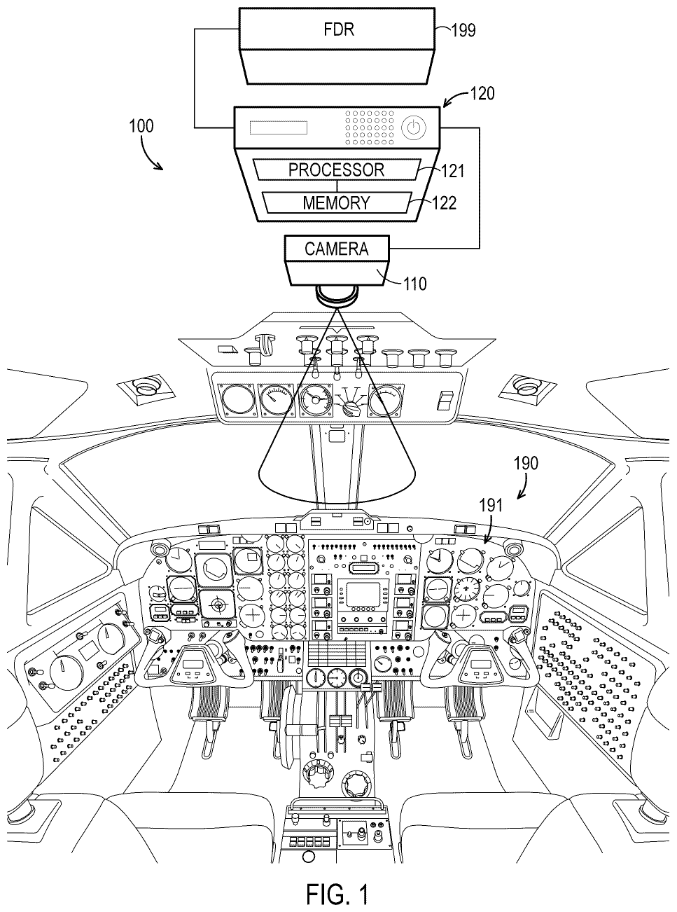

To provide concrete examples, this document focuses on how the data acquisition systems may be used in airplane cockpits. A representative cockpit 190 is depicted in FIGS. 1-3. The reader can see that cockpit 190 includes a plurality of instruments displaying flight-relevant data and multiple controls used to control flight of the airplane. Many of the instruments are mounted on an instrument panel 191.

The instruments included in cockpit 190 include an attitude indicator 180, a dial indicator 181, and a heading indicator 182. The controls included in cockpit 190 include a toggle switch control 183, a slider control 184, a push-pull control 185, a rotary dial control 186. FIGS. 1-3 make apparent that cockpit 190 includes additional instruments and controls as well.

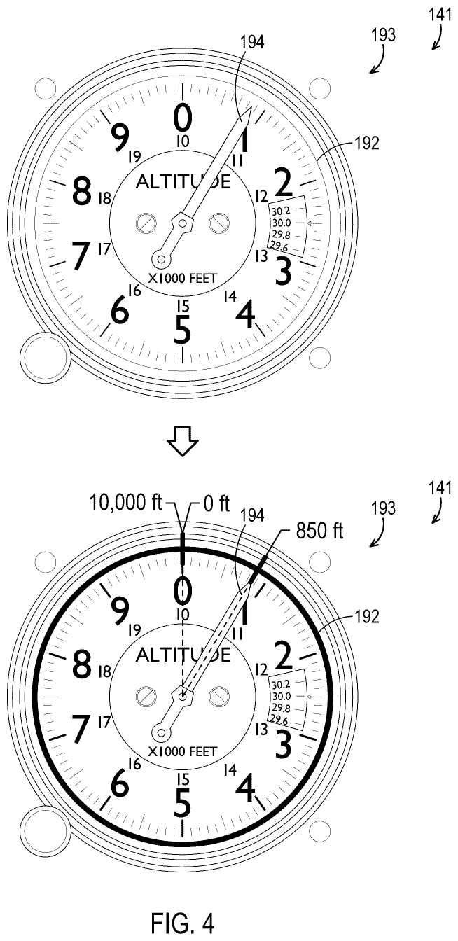

A selected instrument 192 in instrument panel 191 is highlighted in an instrument image 193 depicted in FIG. 4. Selected instrument 192 is an altimeter. As shown in FIG. 4, the main dial of selected instrument 192 indicates current altitude about a range of 0-10,000 ft. Different altimeters will have different main dial ranges.

The instruments and controls in a given cockpit will vary as will the number, size, and location of the instruments and controls. The data acquisition systems described herein may be used in cockpits or control centers with any given arrangement of instruments and controls, including with cockpits having additional or fewer instruments and controls than depicted in FIGS. 1-3.

### Data Acquisition Systems for Cockpits

With reference to the figures, data acquisition systems for cockpits will now be described. The data acquisition systems discussed herein function to acquire flight data from instruments and controls. Optionally, the data acquisition systems described in this document may transfer acquired flight data to a flight data recorder or other computer memory location.

The reader should understand that terms like flight data and flight data recorder are used for convenience and concreteness given that this document focuses on using the data acquisition systems in airplane cockpit contexts. More general terminology like control data could be used instead of flight data when the data acquired by the data acquisition systems does not pertain to aircraft cockpits. Likewise, the term data store could be used instead of flight data recorder outside of aircraft applications.

The reader will appreciate from the figures and description below that the presently disclosed data acquisition systems address many of the shortcomings of conventional data acquisition systems. For example, the novel data acquisition systems acquire flight data from instruments and controls in a cockpit without needing to install wiring and analog/digital behind an instrument panel. Desirably, the novel data acquisition systems are effective to acquire flight data from a plurality of instruments and controls without needing to individually wire each instruments and controls to an analog/digital converter box.

### Data Acquisition System Embodiment One

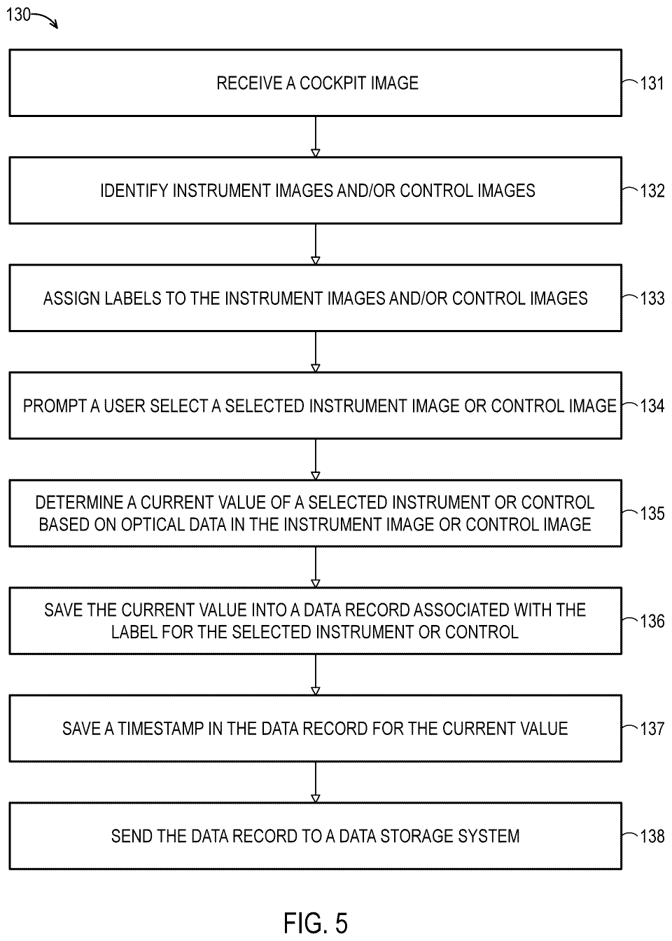

With reference to FIGS. 1-7, a first example of a data acquisition system, data acquisition system 100, will now be described. FIGS. 1-4 depict how data acquisition system 100 interacts with cockpit 190 and selected instrument 192 of cockpit 190. FIGS. 5-7 demonstrate computer instructions 130 utilized by data acquisition system 100.

Data acquisition system 100 functions to acquire flight data from instruments and controls of cockpit 190. Further, data acquisition system 100 transfers acquired flight data to a data storage system 199. In the present example, data storage system 199 is a flight data recorder, but may be any computer memory system or device.

In some examples, the data acquisition system does not transfer data to a flight data recorder or onboard data storage system. Indeed, in some examples the data acquisition system transmits or steams real-time data to receivers accessible by pilots or to personnel or systems on the ground. The data acquisition system may transfer data via satellite or 5G wireless communication protocols.

In one application, the data acquisition system transfers data to a monitoring system on the ground that issues warnings to pilots and/or ground personnel when certain limits are exceeded. For example, an airline may implement a program where the data acquisition system monitors engine vibration in real-time for all aircraft in flight. In such examples, the data acquisition may issue or cause to be issued warnings to ground operation personnel and pilots anytime vibrations exceeded set limits.

Data acquisition system 100 is in data communication with data storage system 199. In the present example, data acquisition system 100 is in wired data communication with data storage system 199, but the data acquisition system may additionally or alternatively be in wireless data communication with the data storage system via any currently known or later developed wireless data communication protocol.

As shown in FIG. 1, data acquisition system 100 includes an image capture device 110 and a data processing system 120. In some examples, the data acquisition system does not include one or more features included in data acquisition system 100. In certain examples, the data acquisition system includes additional or alternative features, such as a flight data recorder or other memory store.

The overall size, shape, and mounting position of the data acquisition systems will be different in different examples. For example, the data acquisition system may have components, such as the data processing system, fully or partially mounted behind panels or in locations remote from the cockpit. The data acquisition system may be larger or smaller than depicted in FIG. 1.

The components of data acquisition system 100 are described in the sections below.

### Image Capture Device

Image capture device 110 functions to capture images of cockpit 190. The images captured by image capture device 110 enable acquiring flight data from instruments and controls in cockpit 190 with data processing system 120.

The reader can see in FIG. 1 that image capture device 110 is in data communication with data processing system 120. In the present example, image capture device 110 is in wired data communication with data processing system 120, but the image capture device may additionally or alternatively be in wireless data communication with the data processing system.

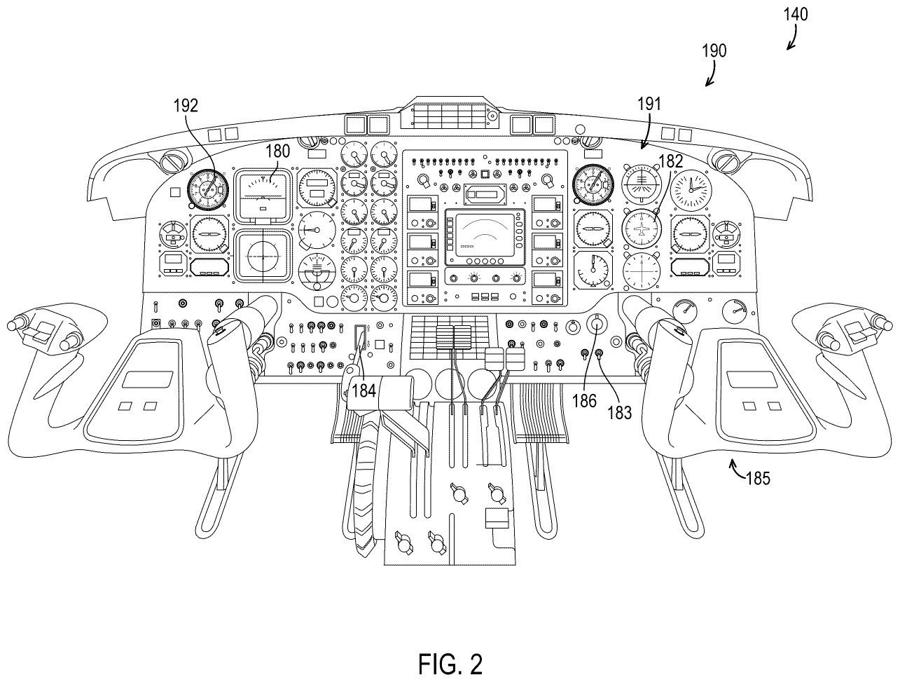

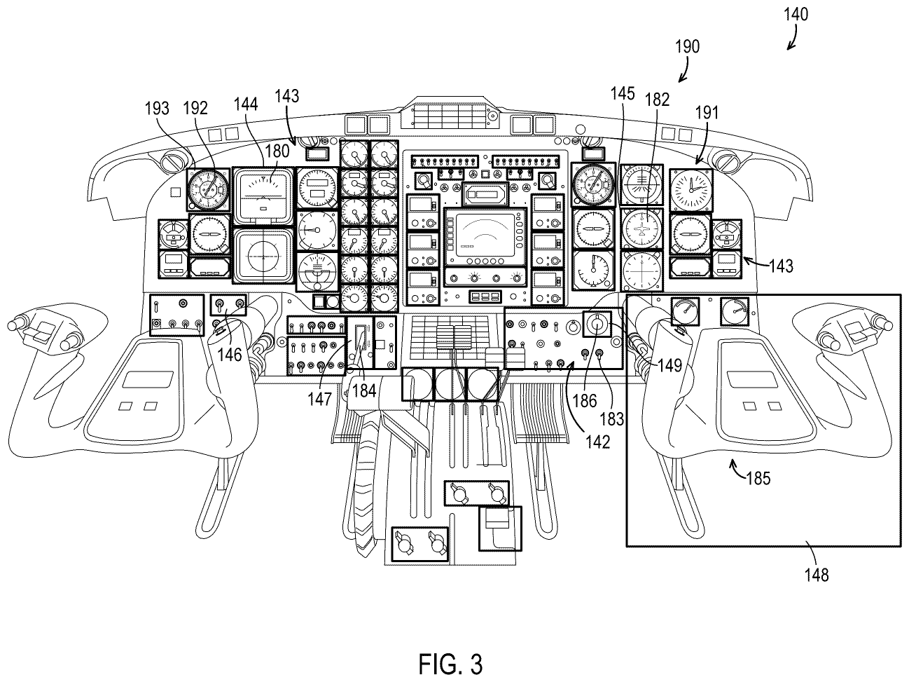

As shown in FIG. 1, image capture device 110 is positioned to capture a cockpit image 140, shown in FIGS. 2 and 3, of a plurality of instruments and controls in cockpit 190. In the example depicted in FIG. 1, image capture device 110 is positioned above instrument panel 191 on a ceiling of cockpit 190. However, the image capture device may be positioned anywhere suitable for capturing images of instruments and controls in the cockpit.

In the present example, a single image capture device is included in data acquisition system 100. In some examples, multiple image capture devices are used to capture images of the instruments and controls in a cockpit. For example, one image capture device may capture images of a first set of instruments and controls and another image capture device may capture images of a second set of instruments and controls.

In some examples, multiple image capture devices are utilized for redundancy. For example, multiple image capture devices may be used to capture images of the same instrument from different positions to account for situations where line-of-sight to the instrument for one of the image capture devices is blocked or obscured.

For example, a pilot's body may block line-of-sight for one image capture device while line-of-sight for another image capture device remains intact. Additionally or alternatively, sun glare may obscure or wash out images captured by one image capture device without impairing another image capture device's ability to capture suitable quality images. The data acquisition systems described herein may include as many image capture devices as desired for redundancy and/or for capturing images of different instruments and controls.

In the present example, image capture device 110 is a digital camera. However, the image capture device may be any currently known or later developed type of device suitable for capturing images. In some examples, the image capture device is configured to capture videos. In the example shown in FIG. 1, image capture device 110 is configured to capture both still images and videos.

In the example shown in FIG. 1, image capture device 110 is fixedly mounted in cockpit 190. In some examples, the image capture device is temporarily mounted within the cockpit, such as with a a carry-on camera, mobile device with camera capabilities, or a wearable device with camera capabilities. Suitable wearable devices with camera capabilities include smart watches and smart glasses, such as Ray-Ban™ or Meta™ smart glasses.

In the present example, image capture device 110 is configured to capture cockpit images at specified intervals. Additionally or alternatively, the image capture device may be configured to capture images on demand or at predetermined, irregular times. Image capture device 110 is configured to associate or assign a timestamp with each cockpit image captured corresponding to when each cockpit image was captured.

The specified intervals may be as frequent as desired, such as multiple times per second, once per second, or once every multiple seconds. More frequent intervals will yield more granular data while consuming more processor bandwidth and computer memory. Less frequent intervals will reduce processor bandwidth and computer memory requirements while providing less data.

### Cockpit Images

Cockpit images 140 are images of the instruments and controls of cockpit 190. Cockpit images 140 include the values displayed at a given time by the instruments of cockpit 190. Additionally, cockpit images 140 include the settings of controls at a given time corresponding to the position of the controls at that given time. For example, the cockpit images may include the current attitude displayed by an attitude indicator or the current throttle magnitude of a throttle control.

FIGS. 2 and 3 depict a cockpit image 140 of cockpit 190 captured by image capture device 110. The reader can see in FIG. 2 that cockpit image 140 includes images of a plurality of instruments and controls in cockpit 190. FIG. 3 depicts a user interface overlay 143 in the form of borders around individual instruments and controls added to cockpit image 140 by data processing system 120.

The cockpit images include a number of instrument images 141 and control images 142. Instrument images 141 correspond to individual instruments in cockpit image 140. As shown in FIG. 4, instrument images 141 include a selected instrument image 193 corresponding to selected instrument 192. In the example shown in FIG. 4, selected instrument 192 is an altimeter.

Control images 142 correspond to individual controls in cockpit image 140. Control images 142 include a selected control image corresponding to a selected control. For example, the selected control image may be an image of a landing gear lever depicting the current position of the landing gear lever, which corresponds to the position of the landing gear absent a malfunction.

With reference to FIG. 2, the reader can see a variety of instrument images 141 and control images 142. Individual instrument images 141 and control images 142 are conceptually isolated and designated by user interface overlay 143.

User interface overlay 143 in the present example takes the form of rectangular borders around the instruments and controls. However, the user interface overlay could take a wide variety of other forms. For example, the user interface overlay could comprise circular borders, dashed line borders, partially transparent color highlights, and/or text or numerical labels.

As depicted in FIG. 2, instrument images 141 include an instrument image 144 of an attitude indicator; an instrument image 193 of a dial indicator shown in more detail in FIG. 4; and an instrument image 145 of a heading indicator. With further reference to FIG. 2, control images 142 include a control image 146 of a toggle switch; a control image 147 of a slider control; a control image 148 of a push-pull control; and a control image 149 of a rotary dial control.

### Data Processing System

Data processing system 120 serves to optically process flight relevant data contained within cockpit images 140, including data from individual instrument images 141 and control images 142 within cockpit images 140. Data processing system 120 optically processing flight relevant data contained within cockpit images 140 yields cockpit data.

The cockpit data includes current values of instruments and current settings of controls. For example, the cockpit data includes a current value of one or more of the plurality of instruments in cockpit image 140. The cockpit data also includes current settings of one or more of the plurality of controls captured in cockpit image 140.

As shown in FIG. 1, data processing system 120 is in data communication with image capture device 110 and with data storage system 199. In the present example, data processing system 120 is in wired data communication with image capture device 110 and data storage system 199. However, the data processing system may additionally or alternatively be in wireless data communication with the image capture device and the data storage system. Any currently known or later developed wireless data communication protocol may be used by the data processing system, the image capture device, and/or the data storage system.

The overall size, shape, and mounting position of the data processing system may be different in different examples. For example, the data processing system may have components fully or partially mounted behind panels or in locations remote from the cockpit. The data processing system may be larger or smaller than depicted in FIG. 1.

In the example shown in FIG. 1, data processing system 120 includes a processor 121, a memory unit 122, and computer instructions 130 (shown in FIGS. 5-7). In other examples, the data processing system may include fewer, additional, or alternative components. The components of data processing system 120 are described further in the sections below.

### Processor

Processor 121 is configured to execute computer instructions 130 to yield cockpit data for instruments and controls in cockpit 190. Processor 121 and computer instructions 130 cooperate to optically process the flight relevant data contained within cockpit images 140 to yield the cockpit data. Processor 121 also functions to save the cockpit data into data records associated with individual instruments and controls for later retrieval.

As shown in FIG. 1, processor 121 is in data communication with memory unit 122, image capture device 110, and data storage system 199. In the present example, processor 121 is in wired data communication with memory unit 122, image capture device 110, and data storage system 199. However, the processor may additionally or alternatively be in wireless data communication with the memory unit, the image capture device, and/or the flight data recorder or other computer memory unit. Any currently known or later developed wireless data communication protocol may be used by the processor, the memory unit, the image capture device, and/or the flight data recorder or other computer memory unit.

In the present example, processor 121 is configured to execute computer instructions 130 to yield the cockpit data at regular intervals. In particular, processor 121 executes computer instructions 130 for each cockpit image 140 captured by image capture device 110 at specified intervals. Additionally or alternatively, the processor may execute the computer instructions to yield cockpit data on demand or at irregular intervals.

The processor may be any currently known or later developed type of computer processor configured to execute computer executable instructions. The processor may include multiple processing units and/or cores. The speed and performance attributes of the processor will vary in different examples.

In the present example, processor 121 saves current values of instruments and current settings of controls into data records. The data records associate a current value or setting of an instrument or control with an identifier or label for the corresponding instrument or control. In the example shown in FIGS. 1-7, processor 121 is instructed to save timestamps into the data records to indicate when the current value or setting of the instrument or control was acquired.

Processor 121 further operates in response to computer instructions 130 to send data records to data storage system 199 on an ongoing basis. The processor sending data records to a data storage system on an ongoing basis is an optional undertaking. For example, the processor could be instructed to wait to send data records to a data storage system until a relatively large batch of records are available to send to a data storage system. In some examples, the data records are not sent to a separate data storage system and instead are saved in the memory unit of the data processing system.

### Memory Unit

Memory unit 122 functions to store computer instructions 130 for use by processor 121. Memory unit 122 may also store data records created by processor 121. The data records saved in memory 122 may optionally be transferred to data storage system 199.

The memory unit may be any currently known or later developed type of computer memory system or device. The memory unit may be located in a common housing with the processor as depicted in FIG. 1 or may be located remote from the processor.

### Computer Instructions

Computer instructions 130 instruct processor 121 to optically process flight relevant data within cockpit images 140 to yield cockpit data. Computer instructions 130 further instruct processor 121 to present user interfaces, including user interface overlays 143, to assist a user to identify and select different instruments and controls for optical processing. A further function of computer instructions 130 is to associate cockpit data with particular instruments and control and to save data records of cockpit data for later retrieval.

In the present example, computer instructions 130 are stored in memory unit 122 contained within a common housing of data processing system 120 with processor 121. However, the computer instructions may be stored in locations remote from the processor, such as remote locations on a local or distributed network.

In general, the computer instructions may be organized into distinct routines, such as a setup routine and a run routine. The computer instructions may be organized into additional or alternative routines or may not be organized into distinct routines at all. Different organization approaches to the computer instructions may achieve the same functions and objectives. Thus, organizing the computer instructions into routines should be considered merely as an organizational tool for user convenience.

The setup routine may occur only once, such as when the data acquisition system is initially being implemented in a specific aircraft. During the setup routine, the user may specify the instruments and/or controls from which he or she wants the data acquisition system to acquire data. The instruments and controls selected may depend on different desired applications, such maintenance monitoring, participating in a Flight Operational Quality Assurance programs, or complying with International Civil Aviation Organization flight data recorder requirements.

The data acquisition system may employ artificial intelligence techniques during the setup routine. The artificial intelligence techniques may assist with identifying where in the cockpit selected instruments and controls reside. Additionally or alternatively, the artificial intelligence techniques may assist with identifying unique indicator characteristics of each instrument and control.

During the setup routine for a given aircraft, the data acquisition system may establish operating software for that specific aircraft. The list of desired instruments and controls, their location information, and their indicator characteristics may be saved as part of the data acquisition system operating software for that specific aircraft.

Once the setup is complete for a specific aircraft, the run routine will reference that operating software when utilizing the data acquisition system in that aircraft. Each time the aircraft is operated, the data acquisition system may automatically run the operating software for that specific aircraft without needing to run the setup routine again. The run routine will ustilize the operating software for a given aircraft to acquire, process and store data for the instruments and controls specified during the setup routine.

With reference to FIG. 5, individual instructions 131-138 included in computer instructions 130 will be described. The reader should understand that the computer instructions may include fewer, additional, or alternative instructions in different examples while still achieving the data acquisition objectives of the data acquisition system.

Instruction 131 instructs processor 121 to receive cockpit image 140 from image capture device 110. When following instruction 132, processor 121 identifies instrument images 141 corresponding to individual instruments in cockpit image 140. Processor 121 further identifies control images 142 corresponding to individual controls in cockpit image 140.

FIG. 3 graphically depicts with user interface overlays 143 processor 121 identifying a plurality of instruments and controls in cockpit 190 pursuant to instruction 132. An individual instrument or control image identified by processor 121 at instruction 132 for a given instrument or control may be selected for optical processing. An instrument image or a control image selected for optical processing is referred to herein as a selected instrument image or a selected control image, respectively. Selected instrument images and selected control images are included in the instrument and control images identified by processor 121 at instruction 132.

Instruction 133 instructs processor 121 to assign labels or identifiers to the individual instrument images. The labels or identifiers enable the user and the system to reference the same instrument or control. Assigning labels at instruction 133 includes assigning a selected instrument label or a selected control image corresponding to an instrument image or control image selected at instruction 134.

Instruction 134 directs processor 121 to request that a user select a selected instrument or control for processing. The selected instrument or control will have a corresponding instrument image or control image, respectively. The instrument image or the control image corresponding to the selected instrument or control is referred to as a selected instrument image or a selected control image. A selected instrument image 193 is depicted in FIG. 4.

In some examples instruction 134 occurs during a setup routine once per aircraft or once per flight. The processor may obtain selected instruments and controls specified during the setup routine from saved operating software. In some examples, all instruments and controls are selected.

When following instruction 135, processor 121 determines a current value of the instrument selected at step 134 or determines a current setting of the control selected at step 134. The current value or current setting determined by processor 121 at step 135 is based on optical data in the selected instrument image or selected control image.

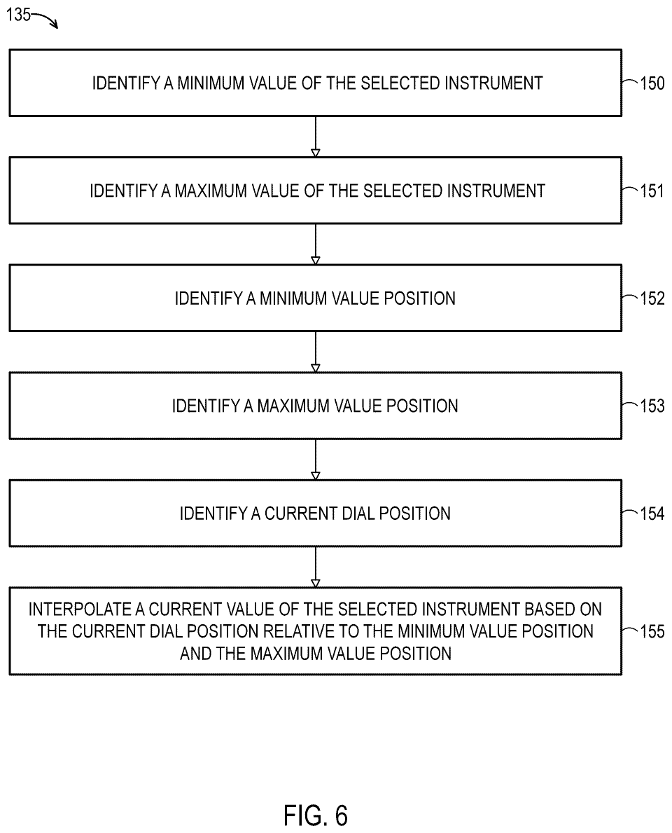

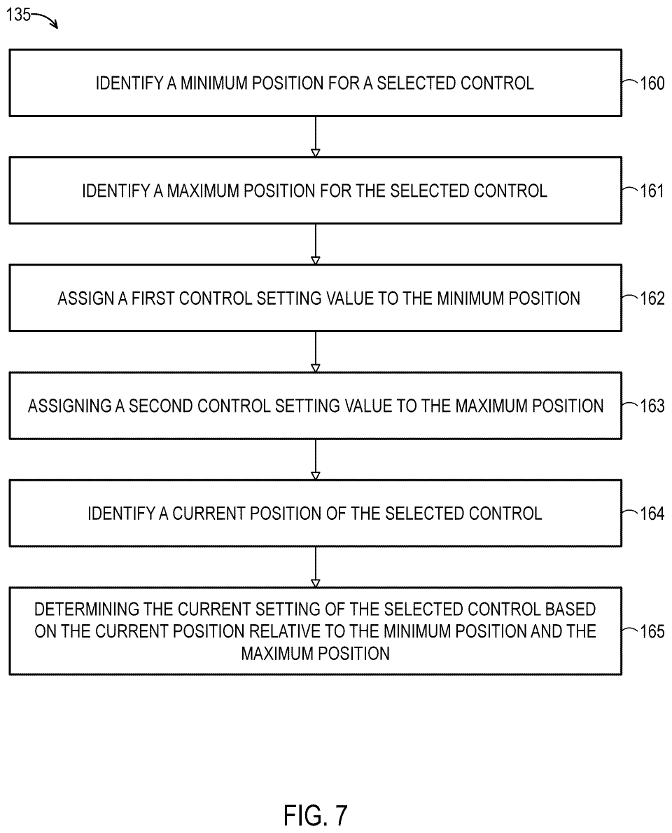

FIGS. 4 and 6 demonstrate how processor 121 determines a current value of selected instrument 192, which is an altimeter. FIG. 7 demonstrate how processor 121 determines a current setting of a selected control.

With reference to FIGS. 4 and 6, more detailed instructions involved with instruction 135 to determines a current value of selected instrument 192 will now be described. Instruction 150 directs processor 121 to identify a minimum value of selected instrument 192. As shown in FIG. 4, the minimum value of selected instrument 192 is 0 feet of altitude. Instruction 151 instructs processor 121 to identify a maximum value of selected instrument 192. As shown in FIG. 4, the maximum value of selected instrument 192 based on the major dial markings is 10,000 feet of altitude.

The minimum and maximum values of selected instrument may be identified by optically scanning selected instrument 192 and machine reading the minimum and maximum dial markings, respectively. Additionally or alternatively, the minimum and maximum values may be entered by a user. In certain examples, an instrument parameter data file with the minimum and maximum values of the instrument is accessed to identify the minimum and maximum values.

When following instruction 152, processor 121 identifies the position of a dial 194 of selected instrument 192 that corresponds to the minimum value of selected instrument 192. In the example shown in FIG. 4, the minimum value position of dial 194 is approximately 0 degrees upwards with a slight rightward tilt. Instruction 153 directs processor 121 to identify the position of dial 194 that corresponds to the maximum value of selected instrument 192. In the example shown in FIG. 4, the maximum value position of dial 194 is approximately 0 degrees upwards with a slight leftward tilt.

Instruction 154 instructs processor 121 to identify a current dial position of dial 194. In the example shown in FIG. 4, the current dial position is approximately 31 degrees. In the present example, processor 121 identifies the current dial position through optical processing of selected instrument image 193.

When following instruction 155, processor 121 interpolates the current value of selected instrument 192 relative to the minimum value and the maximum value identified at instructions 150 and 151. The interpolation undertaken by processor 121 at instruction 155 is based on the current dial position identified at step 154 relative to the minimum value position identified at instruction 152 and the maximum value position identified at instruction 153.

Any suitable means for interpolating the current value of the selected instrument based on the dial positions and values may be used. In some examples, the selected instrument displays alphanumerical values and interpolating values is not necessary or undertaken. In examples where an instrument displays values as text or numbers, the data processing system may directly read and convert the text and numbers displayed by an instrument into quantitative values via optical processing and machine reading techniques.

Other contextual data may be referenced to differentiate between minimum and maximum values when the current position of dial 194 is at 0 degrees upwards. For example, processor 121 may consider dial positions immediately prior to a current dial position to indicate whether dial 194 pointing upwards is more likely to indicate a minimum or maximum value. If immediately prior dial positions were close to 0 ft, such as 200 ft, then 100 feet, etc., processor may interpret dial 194 at 0 degrees to represent a 0 ft reading consistent with a landing. If immediately prior dial positions were close to 10,000 ft, such as 9,500 ft, then 9,900 feet, etc., processor may interpret dial 194 at 0 degrees to represent a 10,000 ft reading.

Turning attention to FIG. 7, more detailed instructions involved with instruction 135 for processor 121 to determine a current setting of a selected control will now be described. The instructions in FIG. 7 for processor 121 to determine a current setting of a control are similar to the instructions shown in FIG. 6 for processor 121 to determine a current value of an instrument.

Instruction 160 directs processor 121 to identify a minimum position of a selected control, and instruction 161 instructs processor 121 to identify a maximum position of the selected control. The minimum and maximum positions of the selected control may be identified by optically scanning the selected control and identifying boundaries on the range of motion of the control. Additionally or alternatively, the minimum and maximum values may be demonstrated to the system by a user in a guided initialization routine.

When following instruction 162, processor 121 assigns a first control setting value to the minimum position of the selected control. Instruction 163 directs processor 121 to assign a second control setting value to the maximum position of the selected control. Instruction 164 instructs processor 121 to identify a current position of the selected control. In the present example, processor 121 identifies the current position of the selected control through optical processing of a selected control image.

When following instruction 165, processor 121 determines the current setting of the selected control. The current setting is determined at instruction 165 based on the current position of the control identified at step 164 relative to the first control setting and the second control setting identified at instructions 160 and 161, respectively.

With reference returning again to FIG. 5, instruction 136 directs processor 121 to save the current value of the selected instrument or the current setting of the selected control into a data record. Processor 121 associates the data record with the instrument label or control label associated with the selected instrument or selected control at step 133, respectively.

Pursuant to instruction 137, processor 121 saves a timestamp in the data record corresponding to when a current value or current setting pertains. The timestamp may include both the date and the time a cockpit image was captured by image capture device 110. Consider an example where image capture device 110 captured a cockpit image at 2:46 PM on Jan. 2, 2024, when a heading indicator indicated an airplane was pointed at 37 degrees and a flaps controller was set at an up position. In this example, processor 121 would save a timestamp of Jan. 2, 2024, 2:46 PM in a data record with the 37 degree heading value and flaps up setting value with corresponding labels for the instrument and control.

Instruction 138 instructs processor 121 to send the data record saved in step 136 and 137 to data storage system 199, which is a flight data recorder in the present example. Instruction 138 is optional and not included in all computer instruction sets utilized by the data acquisition systems described herein.

In some examples, multiple instrument and/or control images are selected for processing instead of a single instrument image or a single control image. For example, a user may specify that all instruments and controls should be processed. In other examples, a user may select three instruments for processing, an instrument and a control for processing, or four controls for processing.

When multiple instruments and/or controls are selected, the computer instructions include instructions for the processor to determine current values of each individual instrument in the multiple instrument images. Further, the computer instructions may include instructing the processor to save the current values of each individual instrument and control into data records associated with each individual instrument and control.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A data acquisition system, comprising:
an image capture device positioned to capture a cockpit image of a plurality of instruments mounted in a cockpit; and
a data processing system in data communication with the image capture device and configured to process the cockpit image to yield cockpit data, the cockpit data including a current value of one or more of the plurality of instruments captured in the cockpit image, the data processing system including:
a memory unit;
computer instructions stored in the memory unit; and
a processor in data communication with the memory unit and the image capture device, the processor configured to execute the computer instructions to yield the cockpit data;
wherein the computer instructions include instructions for the processor to:
receive the cockpit image from the image capture device;
identify instrument images corresponding to individual instruments in the cockpit image including a selected instrument image corresponding to a selected instrument;
assign labels to the individual instrument images, including a selected instrument label corresponding to the selected instrument image;
determine a current value of the selected instrument based on optical data in the selected instrument image; and
save the current value of the selected instrument into a data record associated with the selected instrument label.

2. The data acquisition system of claim 1, wherein the cockpit image includes images of a plurality of instruments displaying flight-relevant data.

3. The data acquisition system of claim 1, wherein the computer instructions include instructions for the processor to send the data record to a data storage system.

4. The data acquisition system of claim 1, wherein:
the image capture device is configured to capture cockpit images at specified intervals; and
the processor is configured to execute the computer instructions to yield the cockpit data for each cockpit image captured at the specified intervals.

5. The data acquisition system of claim 4, wherein:
the image capture device is configured to associate a timestamp with each cockpit image corresponding to when each cockpit image was captured; and
the computer instructions include instructions for the processor to save the timestamp in the data record for the current value of the selected instrument.

6. The data acquisition system of claim 1, wherein determining a current value of the selected instrument includes:
identifying a minimum value of the selected instrument in the selected instrument image;
identifying a maximum value of the selected instrument in the selected instrument image;
identifying a minimum value position of the selected instrument in the selected instrument image;
identifying a maximum value position of the selected instrument in the selected instrument image;
identifying a current dial position of the selected instrument in the selected instrument image; and
interpolating the current value of the selected instrument relative to the minimum value and the maximum value based on the current dial position relative to the minimum value position and the maximum value position.

7. The data acquisition system of claim 1, wherein the computer instructions further include instructions for the processor to request that a user select the selected instrument.

8. The data acquisition system of claim 1, wherein:
multiple instrument images are selected for processing; and
the computer instructions include instructions for the processor to determine current values of each individual instrument in the multiple instrument images.

9. The data acquisition system of claim 8, wherein the computer instructions further include instructions for the processor to save the current values of each individual instrument into data records associated with each individual instrument.

10. The data acquisition system of claim 1, wherein:
the cockpit image includes a plurality of controls of the cockpit; and
the cockpit data includes a current setting of one or more of the plurality of controls in the cockpit image.

11. The data acquisition system of claim 10, wherein the computer instructions include instructions for the processor to:
identify control images corresponding to individual controls in the cockpit image including a selected control image corresponding to a selected control;
assign labels to the individual control images, including a selected control label corresponding to the selected control;
determine a current setting of the selected control based on optical data in the selected control image; and
save the current setting of the selected control into a data record associated with the selected control label.

12. The data acquisition system of claim 11, wherein determining a current setting of the selected control includes:
identifying a minimum position for the selected control in the selected control image;
identifying a maximum position for the selected control in the selected control image;
assigning a first control setting value to the minimum position of the selected control;
assigning a second control setting value to the maximum position of the selected control;
identifying a current position of the selected control in the selected control image;
determining the current setting of the selected control relative to the first control setting and the second control setting based on the current position of the selected control relative to the minimum position and the maximum position.

13. The data acquisition system of claim 11, wherein the control images correspond to controls used to control operation of an aircraft.

14. The data acquisition system of claim 11, wherein the control images include an image of a toggle switch.

15. The data acquisition system of claim 11, wherein the control images include an image of a slider control.

16. The data acquisition system of claim 11, wherein the control images include an image of a push-pull control.

17. The data acquisition system of claim 11, wherein the control images include an image of a rotary dial control.

18. The data acquisition system of claim 1, wherein the instrument images include an image of an attitude indicator.

19. The data acquisition system of claim 1, wherein the instrument images include an image of a dial indicator.

20. The data acquisition system of claim 1, wherein the instrument images include an image of a heading indicator.
